(19) United States
(12) Patent Application Publication
(10) Pub. No.: US 2013/0061841 A1
(43) Pub. Date: Mar. 14, 2013

(54) SAW WIRE AND METHOD OF MANUFACTURING GROUP III NITRIDE CRYSTAL SUBSTRATE USING THE SAME

(71) Applicants: Naoki MATSUMOTO, Itami-shi (JP); Hidenori Mikami, Itami-shi (JP)

(72) Inventors: Naoki MATSUMOTO, Itami-shi (JP); Hidenori Mikami, Itami-shi (JP)

(73) Assignee: SUMITOMO ELECTRIC INDUSTRIES, LTD., Osaka-shi (JP)

(21) Appl. No.: 13/590,257

(22) Filed: Aug. 21, 2012

Related U.S. Application Data
(60) Provisional application No. 61/532,693, filed on Sep. 9, 2011.

(30) Foreign Application Priority Data
Sep. 9, 2011 (JP) 2011-196799

(51) Int. Cl. B28D 5/04

(52) U.S. Cl. 125/21

(57) ABSTRACT

A method of manufacturing a group III nitride crystal substrate slices a group III nitride crystal body with a saw wire which includes a steel wire having a carbon concentration of 0.90-0.95 mass %, a silicon concentration of 0.12-0.32 mass %, a manganese concentration of 0.40-0.90 mass %, a phosphorus concentration of 0.025 mass % or less, a sulfur concentration of 0.025 mass % or less, and a copper concentration of 0.20 mass % or less, and has a diameter of not less than 0.07 mm and less than 0.16 mm, a tensile strength at break of higher than 4200 N/mm², and a curl size of 400 mm or more, with a tension of not less than 50% and not more than 65% of the tension at break applied to the saw wire. Thus, group III nitride crystal substrates with small warpage can be manufactured.

### BACKGROUND OF THE INVENTION

1. Field of the Invention

The present invention relates to a saw wire suitably used for manufacturing a group III nitride crystal substrate, and a method of manufacturing a group III nitride crystal substrate using the saw wire.

2. Description of the Background Art

Crystal substrates are generally manufactured by slicing a crystal body grown in any of various ways. Regarding how to slice the crystal body, methods of slicing by means of various saw wires have been proposed.

For example, Japanese Patent Laying-Open No. 2000-233356 discloses a method of cutting a workpiece by means of a saw wire including a wire having a tensile strength of 3200 to 4200 N/mm² and an average hardness of 730 to 900 Hv, with the aim of reducing waviness of a cut plane of the cut workpiece. Japanese Patent Laying-Open No. 2000-328188 discloses a steel wire to be used for a wire saw with the aim of improving properties of a cut plane of a work (workpiece). The whole length of the steel wire exhibits a curl size (diameter) (herein refers to the size (diameter) of a loop which is formed naturally by the wire when the wire is put on a flat glass plate which is placed horizontally) of 320 mm or more, and the wire has a tensile strength of 2500 MPa or more and a diameter of 0.05 to 0.2 mm. Japanese Patent Laying-Open No. 2000-080442 discloses a steel wire rod in which the concentration of sulfur is 0.0005 to 0.020% by mass and the sum of respective ratios of areas occupied respectively by pro-eitectoid cementite and martensite to the structure is 5% or less, with the aim of providing an ultrathin steel wire which is excellent in wire-drawability. Japanese Patent Laying-Open No. 2005-111653 discloses a saw wire having an out-of-roundness of 0.8 μm or less with the aim of obtaining a cut product which is excellent in precision of a sliced plane. Japanese Patent Laying-Open No. 2000-087285 discloses a plated steel wire to be used for a wire saw that has one or more plate layers on the steel wire, with the aim of improving surface properties of a cut product.

Furthermore, Japanese Patent Laying-Open No. 2006-190909 discloses that, in order to reduce the rate of occurrence of cracks when an ingot of a hexagonal group III nitride crystal is cut, the direction in which a wire is extended when the ingot is cut with the wire is inclined by 3° or more relative to the {1-100} plane of the ingot.

### SUMMARY OF THE INVENTION

A group III nitride crystal body such as GaN crystal body is generally low in terms of the crystal growth rate and complicated in terms of the manufacture process, and is therefore very expensive. In order to obtain a greater number of group III nitride crystal substrates from such an expensive group III nitride crystal body, it is necessary to reduce the kerf loss (material loss during a cutting process). When a conventional saw wire is used to slice a group III nitride crystal body into thin pieces, a resultant problem is that cracks are likely to open and the yield of group III nitride crystal substrates is low. Thus, there has been a demand for a saw wire thinner than conventional ones.

A group III nitride crystal body with a hexagonal wurtzite crystal structure has its polarity along the <0001> direction, and its Ga-atom surface which is a (0001) plane and its N-atom surface which is a (000-1) plane have respective hardnesses different from each other. Due to this, when the group III nitride crystal body is sliced along planes parallel with the (0001) plane and the (000-1) plane to obtain a group III nitride crystal substrate whose main surfaces are Ga-atom surface and N-atom surface, warpage occurs to the main surfaces. In order to reduce this warpage, the tension applied to the saw wire when the group III nitride crystal body is sliced (this tension is hereinafter referred to as stretch tension) should be higher than 8 N, preferably higher than 10 N. An increased tension (stretch tension) applied to the saw wire results in a problem of an increased probability of wire breakage during a slicing process.

Regarding a conventional saw wire like those disclosed in the above-referenced patent literatures, which is for example a saw wire having SWRS82A defined by the JIS G3502:2004 as a steel material for the wire and having a diameter of 0.08 mm, an applied tension of 10 N or more causes the probability of wire breakage during a slicing process to increase. It has thus been difficult to slice a group III nitride crystal body with safety and with a high yield.

An object of the present invention is to provide a method of manufacturing a group III nitride crystal substrate by which group III nitride crystal substrates with small warpage can be manufactured with a high yield, by means of a thin saw wire having a high tensile strength at break.

According to an aspect of the present invention, a method of manufacturing a group III nitride crystal substrate includes the steps of preparing a group III nitride crystal body and producing a group III nitride crystal substrate by slicing the group III nitride crystal body with a saw wire. Here, the saw wire includes a steel wire having a carbon concentration of not less than 0.90 mass % and not more than 0.95 mass %, a silicon concentration of not less than 0.12 mass % and not more than 0.32 mass %, a manganese concentration of not less than 0.40 mass % and not more than 0.90 mass %, a phosphorus concentration of not more than 0.025 mass %, a sulfur concentration of not more than 0.025 mass %, and a copper concentration of not more than 0.20 mass %, and the saw wire has a diameter of not less than 0.07 mm and less than 0.16 mm, a tensile strength at break of higher than 4200 N/mm², and a curl size of not less than 400 mm. A tension of not less than 50% and not more than 65% of a tension at break of the saw wire is applied to the saw wire when the group III nitride crystal body is sliced.

Regarding the method of manufacturing a group III nitride crystal substrate according to the aspect of the present invention, the saw wire may have a diameter of not less than 0.07 mm and not more than 0.10 mm. The steel wire of the saw wire may have a surface plated with brass. The group III nitride crystal substrate may have a thickness of not less than 200 μm and not more than 350 μm.

According to another aspect of the present invention, a saw wire includes a steel wire having a carbon concentration of not less than 0.90 mass % and not more than 0.95 mass %, a silicon concentration of not less than 0.12 mass % and not more than 0.32 mass %, a manganese concentration of not less than 0.40 mass % and not more than 0.90 mass %, a phosphorus concentration of not more than 0.025 mass %, a sulfur concentration of not more than 0.025 mass %, and a copper concentration of not more than 0.20 mass %. The saw wire has a diameter of not less than 0.07 mm and less than 0.16 mm, a tensile strength at break of higher than 4200 N/mm², and a curl size of not less than 400 mm.

Regarding the saw wire according to the aspect of the present invention, the saw wire may have a diameter of not less than 0.07 mm and not more than 0.10 mm. The steel wire of the saw wire may have a surface plated with brass.

In accordance with the present invention, a method of manufacturing a group III nitride crystal substrate can be provided by which group III nitride crystal substrates with small warpage can be manufactured with a high yield, by means of a thin saw wire having a high tensile strength at break.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view illustrating an example of the method of slicing a group III nitride crystal body in accordance with a method of manufacturing a group III nitride crystal substrate according to the present invention.

FIG. 2 is a schematic diagram showing a track of the wire when the group III nitride crystal body is sliced in accordance with the method illustrated in FIG. 1.

FIG. 3 is an enlarged schematic cross-sectional view of the group III nitride crystal body sliced in accordance with the method illustrated in FIG. 1.

FIG. 4 is a chart illustrating a method of manufacturing a group III nitride crystal substrate according to the present invention.

### DESCRIPTION OF THE PREFERRED EMBODIMENTS

### First Embodiment

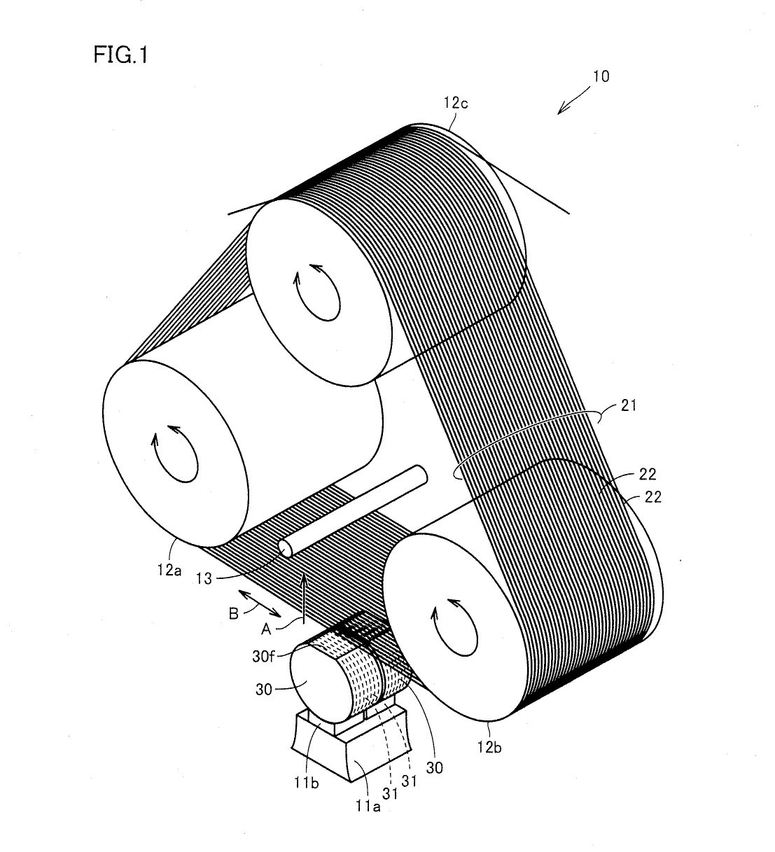

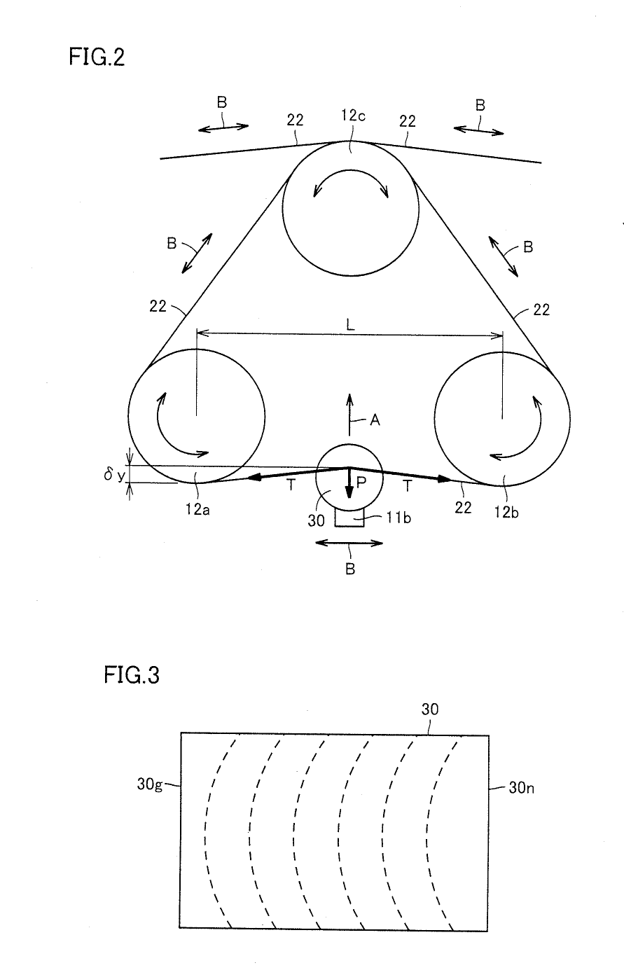

Referring to FIGS. 1 and 2, a saw wire 22 in an embodiment of the present invention includes a steel wire having a carbon concentration of not less than 0.90 mass % and not more than 0.95 mass %, a silicon concentration of not less than 0.12 mass % and not more than 0.32 mass %, a manganese concentration of not less than 0.40 mass % and not more than 0.90 mass %, a phosphorus concentration of not more than 0.025 mass %, a sulfur concentration of not more than 0.025 mass %, and a copper concentration of not more than 0.20 mass %. Saw wire 22 of the present embodiment includes the above-described steel wire, and therefore, the saw wire has a high tensile strength at break and a high tension can be applied thereto without breaking the wire even if the wire is a thin wire of a small diameter.

The steel wire included in saw wire 22 of the present embodiment has the following chemical components in order to have a high tensile strength at break. Carbon is an element that is effective in ensuring the tensile strength at break. If the carbon concentration is lower than 0.90 mass %, it is difficult to give high strength to the steel wire. If the carbon concentration is higher than 0.95 mass %, the steel wire is hard and brittle. Silicon is an element that is effective in deoxidation (herein refers to reduction of the oxygen content in the steel wire). If the silicon concentration is lower than 0.12 mass %, silicon is less effective in its function. If the silicon concentration is higher than 0.32 mass %, a decarburized layer (herein refers to a layer generated when the steel is heated in an acidic atmosphere and reaction of carbon in the steel with oxygen in the acidic atmosphere causes carbon to be removed from the surface layer of the steel, and this decarburized layer has a deteriorated strength and a significantly deteriorated antifatigue strength) is partially generated to deteriorate the antifatigue property of the steel wire. Manganese has, in addition to the above-described deoxidizing function, a function of enhancing the wire drawability by fixing sulfur in the steel wire, in the form of MnS which is a sulfide inclusion. If the manganese concentration is lower than 0.40 mass %, manganese is less effective in terms of the above-described functions. If the manganese concentration is higher than 0.90 mass %, the content of the sulfide inclusion is higher and the wire is more likely to be broken in a wire-drawing process and segregation of manganese may cause cuppy breakage (herein refers to a V-shaped crack breakage occurring within the material). Phosphorus deteriorates the wire drawability. Therefore, the phosphorus concentration is not more than 0.025 mass %. While sulfur may not be present, sulfur, if present, has a function of enhancing the wire drawability by forming a sulfide inclusion. If the sulfur concentration is higher than 0.025 mass %, the content of the sulfide inclusion is higher to cause deterioration of the wire drawability. While copper may not be present, copper, if present, has a function of enhancing the corrosion resistance. If the copper concentration is higher than 0.20 mass %, it segregates at the grain boundary and crack or flaw is likely to occur in a hot process such as hot rolling of the wire rod.

Saw wire 22 of the present embodiment has a wire diameter of not less than 0.07 mm and less than 0.16 mm. Since the wire diameter is smaller than a common wire diameter of 0.16 mm of the conventional saw wire, the kerf loss (material loss during cutting process) when the group III nitride crystal body is sliced is reduced and occurrence of cracks when the group III nitride crystal body is sliced into thin pieces is suppressed. Accordingly, the yield of group III nitride crystal substrates is improved. Furthermore, since the wire diameter is not less than 0.07 mm, the tension at break of the wire is increased. In this respect, the diameter of saw wire 22 is preferably not less than 0.07 mm and not more than 0.10 mm.

Saw wire 22 of the present embodiment has a tensile strength at break of higher than 4200 N/mm². Since the tensile strength at break of the wire is higher than 4200 N/mm², the saw wire, even if its diameter is not less than 0.07 mm and less than 0.16 mm, preferably not less than 0.07 mm and not more than 0.10 mm, more preferably not less than 0.08 mm and not more than 0.10 mm, can have a high tension at break. Therefore, a high tension can be applied to the wire without causing breakage of the wire.

Saw wire 22 of the present embodiment has a curl size of not less than 400 mm. Since the curl size of the wire is 400 mm or more, torsion of the wire can be reduced that occurs during reciprocation (positive turn, reverse turn) of the wire in a slicing process, and wire breakage trouble due to the decreased strength caused by torsion can be suppressed. In this respect, the wire preferably has a curl size of not less than 450 mm.

In saw wire 22 of the present embodiment, preferably the above-described steel wire has a surface plated with brass. Since the surface of the steel wire is plated with brass, the hardness of the surface of the saw wire is lowered to improve the state where the abrasive bites into the saw wire and improve the properties of the slice surface of the sliced group III nitride crystal body. Here, brass is an alloy of copper and zinc, and generally the zinc content is up to 45 mass %. The way to plate the surface of the steel wire is not particularly limited, and electroplating, electroless plating, melt plating or the like is used. While the thickness of the plate layer formed on the surface of the steel wire is not particularly limited, the thickness after final wire-drawing is preferably not less than 0.05 μm and not more than 0.6 μm.

The method of manufacturing saw wire 22 of the present embodiment is not particularly limited. In order to efficiently manufacture a saw wire, however, the method includes, for example: the step of producing a primary wire having a diameter of approximately not less than 0.5 mm and not more than 1.5 mm by heat treatment and wire drawing performed on a steel wire rod an appropriate number of times (primary wire production step); and the step of producing a secondary wire having a diameter of not less than 0.07 mm and less than 0.16 mm by patenting-heat-treatment, plating as required, and another wire drawing performed on the primary wire (secondary wire production step).

### Second Embodiment

Referring to FIGS. 1 to 4, a method of manufacturing a group III nitride crystal substrate in another embodiment of the present invention includes the step S1 of preparing a group III nitride crystal body 30 and the step S2 of producing a group III nitride crystal substrate 31 by slicing group III nitride crystal body 30 with saw wire 22 of the first embodiment. This manufacturing method can be used to obtain small-warpage group III nitride crystal substrates with a high yield.

Step of Preparing Group III Nitride Crystal Body

Referring to FIGS. 1, 2, and 4, the method of manufacturing a group III nitride crystal substrate of the present embodiment includes the step S1 of preparing group III nitride crystal body 30. In the step S1 of preparing group III nitride crystal body 30, the method of producing group III nitride crystal body 30 is not particularly limited. Vapor phase methods such as HVPE (hydride vapor phase epitaxy) method, MBE (molecular beam epitaxy) method, MOVPE (metal organic vapor phase epitaxy) method, and sublimation method, liquid phase methods such as flux method and high nitrogen pressure solution method, ammonothermal growth method, and the like, are suitably used.

Step of Producing Group III Nitride Crystal Substrate

Referring to FIGS. 1, 2, and 4, the method of manufacturing a group III nitride crystal substrate of the present embodiment includes the step S2 of producing group III nitride crystal substrate 31 by slicing group III nitride crystal body 30 with saw wire 22 of the first embodiment.

In order to slice group III nitride crystal body 30, saw wire 22 of the first embodiment is used. Saw wire 22 of the first embodiment includes a steel wire having a carbon concentration of not less than 0.90 mass % and not more than 0.95 mass %, a silicon concentration of not less than 0.12 mass % and not more than 0.32 mass %, a manganese concentration of not less than 0.40 mass % and not more than 0.90 mass %, a phosphorus concentration of not more than 0.025 mass %, a sulfur concentration of not more than 0.025 mass %, and a copper concentration of not more than 0.20 mass %. The saw wire has a diameter of not less than 0.07 mm and less than 0.16 mm, a tensile strength at break of higher than 4200 N/mm², and a curl size of not less than 400 mm. Since saw wire 22 used in the present embodiment is saw wire 22 of the first embodiment, the description thereof will not be repeated here.

Referring to FIG. 1, the method of slicing group III nitride crystal body 30 with saw wire 22 is not particularly limited. In order to efficiently slice the crystal body, a method of slicing it with a multi-wire saw 10 may suitably be used.

Multi-wire saw 10 includes a work support platform 11a, a work support member 11b, guide rollers 12a, 12b, 12c, a slurry nozzle 13, and a saw wire string 21 formed by a single saw wire 22 stretched on the rollers 12a, 12b, 12c. These components of multi-wire saw 10 are each supported by a housing (not shown).

Work support platform 11a is disposed below other components. At least one group III nitride crystal body 30 is fixed above work support platform 11a with work support member 11b interposed therebetween. Work support platform 11a is mounted on a movable table (not shown), and this movable table moves vertically upward to carry group III nitride crystal body 30 vertically upward (feed direction A indicated by arrow A in FIGS. 1 and 2).

Guide rollers 12a, 12b, 12c are each a rotating body having a substantially columnar shape, and are arranged so that respective rotational axes are orthogonal to the vertical direction (feed direction A) and are parallel with each other. Guide roller 12a and guide roller 12b are arranged so that they are separated from each other on the left side and the right side with respect to an imaginary vertical line passing through work support platform 11a. Guide roller 12c is disposed above guide rollers 12a and 12b and on the imaginary vertical line passing through work support platform 11a.

On respective outer peripheral surfaces of these guide rollers 12a, 12b, 12c, a plurality of grooves are formed in parallel with each other and at regular intervals. In these grooves, a single saw wire 22 is spirally extended to form saw wire string 21. Saw wire 22 is caused to reciprocate in two directions by alternately repeated positive turn and reverse turn of guide rollers 12a, 12b, 12c. Of saw wire 22 stretched on these guide rollers 12a, 12b, 12c, the portion running under guide rollers 12a and 12b runs in the position crossing group III nitride crystal body 30 which has been fed upward by movement of work support platform 11a.

Slurry nozzle 13 is provided for jetting toward saw wire 22 and group III nitride crystal body 30 a slurry (abrasive solution) obtained by mixing a loose abrasive in a lapping oil.

The method of slicing with multi-wire saw 10 may for example be the following one. An orientation flat plane 30f is formed on one or more group III nitride crystal bodies 30 that are each a work (workpiece). While the orientation flat plane is not particularly limited, a plane perpendicular to the (1-100) plane with high cleavage property is preferred. For example, (11-20) plane is preferred. This group III nitride crystal body 30 is fixed on work support platform 11a with work support member 11b interposed therebetween so that its orientation flat plane 30f is parallel with the direction along which saw wire 22 extends (the direction identical to the running direction B of saw wire 22 indicated by arrow B in FIGS. 1 and 2).

Subsequently, guide rollers 12a, 12b, 12c are turned in the positive direction and the reverse direction alternately to start reciprocation of saw wire 22. Then, work support platform 11a on which group III nitride crystal body 30 is fixed is moved upward to thereby feed group III nitride crystal body 30 to saw wire string 21. At this time, a slurry starts being jetted from slurry nozzle 13 toward saw wire string 21 and group III nitride crystal body 30. Group III nitride crystal body 30 is accordingly brought into contact with saw wire 22, and the slurry entering between group III nitride crystal body 30 and saw wire 22 serves to start cutting of group III nitride crystal body 30. While the slurry is supplied, group III nitride crystal body 30 is fed at a substantially constant speed in feed direction A. In this way, group III nitride crystal body 30 is sliced into group III nitride crystal substrates 31 of a thickness corresponding to the interval between the wires of saw wire 22 in saw wire string 21.

Here, referring to FIG. 2, when group III nitride crystal body 30 is sliced, flexure δy of saw wire 22 is represented by a formula (1) below using a cutting resistance P in the cutting direction (the opposite direction to feed direction A) of group III nitride crystal body 30 against saw wire 22, a distance L between guide roller 12a and guide roller 12b, and a tension (stretch tension) T applied to the saw wire.

$$δ y = \frac{PL}{4 T} \qquad ( 1 )$$

Referring also to FIG. 3, group III nitride crystal body 30 has a hexagonal wurtzite crystal structure having its polarity along the <0001> direction, and a Ga-atom surface 30g which is a (0001) plane and an N-atom surface 30n which is a (000-1) plane have respective hardnesses different from each other. Therefore, main surfaces of the group III nitride crystal substrate are warped. Specifically, the main surfaces are Ga-atom surface 30g and N-atom surface 30b respectively obtained by slicing group III nitride crystal body 30 along respective planes parallel with the (0001) plane and the (000-1) plane, and the main surfaces are warped in such a manner that Ga-atom surface 30g is the convex side and N-atom surface 30n is the concave side. In order to reduce this warpage, it is necessary to increase the tension (stretch tension) T applied to the saw wire when the group III nitride crystal body is sliced and thereby reduce flexure δy of saw wire 22.

When group III nitride crystal body 30 is sliced in accordance with the method of manufacturing a group III nitride crystal substrate of the present embodiment, tension T which is not less than 50% and not more than 65% of the tension at break is applied to saw wire 22. Here, because saw wire 22 has a wire diameter of not less than 0.07 mm and less than 0.16 mm and a tensile strength at break of higher than 4200 N/mm², the tension at break of the saw wire is larger than 16.16 N. Namely, tension T which is larger than 8.08 N is applied to saw wire 22. Thus, flexure δy of saw wire 22 is reduced and the warpage of the main surfaces (Ga-atom surface and N-atom surface) of group III nitride crystal substrate 31 can be lessened.

Step of Simultaneously Polishing Both Main Surfaces of Group III Nitride Crystal Substrate

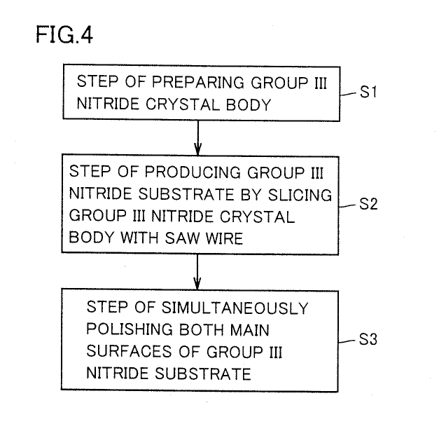

Referring to FIG. 4, the method of manufacturing a group III nitride crystal substrate of the present embodiment may further include the step S3 of simultaneously polishing both main surfaces of the group III nitride crystal substrate. Since the method of manufacturing a group III nitride crystal substrate of the present embodiment can reduce warpage of both main surfaces of the group III nitride crystal substrate, the yield of the simultaneous polishing of both main surfaces is improved.

The method of simultaneously polishing both main surfaces of the group III nitride crystal substrate is not particularly limited. In order to efficiently obtain smooth main surfaces, however, mechanical polishing, chemical mechanical polishing and the like are suitably used.

### EXAMPLE A

1. Preparation of Group III Nitride Crystal Body

A GaN crystal body (group III nitride crystal body) grown by the HVPE method and having a front main surface which was a Ga-atom surface ((0001) plane) and a rear main surface which was an N-atom surface ((000-1) plane) was contour-processed through the following procedure. The outer periphery of the GaN crystal body was ground with a diamond abrasive of #800 defined by JIS R6001:1998 so that the diameter was 50.8 mm (2 inches). The front main surface and the rear main surface of the GaN crystal body were ground with a diamond abrasive of #1000 defined by JIS R6001:1998 to shape the GaN crystal body so that the thickness of the GaN crystal body was 20 mm. On the outer periphery of the GaN crystal body, an orientation flat plane which was a (11-20) plane was formed with a diamond abrasive of #800 defined by JIS R6001:1998. Finally, process strain that occurred due to the process was removed by wet etching or dry etching.

2. Production of Group III Nitride Crystal Substrate

2-1. Preparation of Saw Wire

A steel wire rod corresponding to SWRS92A defined by JIS G3502:2004, specifically a steel wire rod having a carbon concentration of 0.92 mass %, a silicon concentration of 0.21 mass %, a manganese concentration of 0.47 mass %, a phosphorus concentration of 0.000 mass %, a sulfur concentration of 0.001 mass %, and a copper concentration of 0.15 mass %, and having a diameter of 5.5 mm was prepared. This steel wire rod was heat-treated and drawn an appropriate number of times to produce a primary wire having a diameter of approximately 0.70 mm (primary wire production step). The obtained primary wire was subjected to patenting-heat-treatment, plated with brass, and further subjected to continuous wet drawing to thereby produce a secondary wire having a diameter of 0.08 mm (secondary wire production step), which was namely a saw wire. The obtained saw wire had a tension at break of 21.6 N, a tensile strength at break of 4300 N/mm², and a curl size of 410 mm. Here, the tension at break and the tensile strength at break were measured by means of a tension tester (UTM-3-100 manufactured by Toyo Baldwin) in an atmosphere of 25° C. and relative humidity of 50%, under the conditions that the gauge length was 300 mm and the tension rate was 100 mm/min. The curl size was measured by means of a vernier caliper.

2-2. Slicing of Group III Nitride Crystal Body

The prepared saw wire was used to slice the prepared GaN crystal body. The GaN crystal body was fixed so that its orientation flat plane ((11-20) plane) was parallel with the direction along which saw wire 22 was extended. The tension (stretch tension) applied to the saw wire was set so that the safety factor (the factor refers to a factor determined by dividing the tension at break of the saw wire by the stretch tension on the saw wire) was any of 1.2, 1.5, 1.6, 1.8, 2.0, 2.5, and 3.0, namely the ratio of the stretch tension to the tension at break was any of 83.3%, 66.7%, 62.5%, 56.6%, 50.0%, 40.0%, and 33.3%. Specifically, the stretch tension on the saw wire was any of 18.0 N (Example A1), 14.4 N (Example A2), 13.5 N (Example A3), 12.0 N (Example A4), 10.8 N (Example A5), 8.64 N (Example A6), and 7.20 N (Example A7). For the slurry, a mineral oil was used as a lapping oil and a diamond abrasive with an average particle size of 6 μm was used as a loose abrasive. The distance between guide rolls was 250 mm. The average running speed of the saw wire was 600 m/min. The slicing rate of the GaN crystal body (feed rate of the crystal body) was 2 mm/hr. A GaN crystal substrate (group III nitride crystal substrate) obtained by slicing this GaN crystal body had a thickness of 350 μm.

Regarding slicing of Example A1 to Example A7 mentioned above, the wire breakage probability during slicing and an average warp of the Ga-atom surface of the GaN crystal substrate obtained by slicing were measured. Here, the wire breakage probability is the probability in percentage of occurrence of wire breakage before the GaN crystal body is sliced 50 times. The average warp is an average level difference between the level of the most convex portion and the level of the most concave portion of respective Ga-atom surfaces of 110 GaN crystal substrates, and measured by means of a contact-type surface roughness tester. Regarding all substrates, the warp perpendicular to the direction in which the saw wire ran was larger than the warp in the direction parallel with the direction in which the saw wire runs.

Regarding slicing of Example Al, the wire breakage probability was 22% and the average warp of the obtained GaN crystal substrates was 12 μm. Regarding slicing of Example A2, the wire breakage probability was 10% and the average warp of the obtained GaN crystal substrates was 14 μm. Regarding slicing of Example A3, the wire breakage probability was 0% and the average warp of the obtained GaN crystal substrates was 15 μm. Regarding slicing of Example A4, the wire breakage probability was 0% and the average warp of the obtained GaN crystal substrates was 28 μm. Regarding slicing of Example A5, the wire breakage probability was 0% and the average warp of the obtained GaN crystal substrates was 30 μm. Regarding slicing of Example A6, the wire breakage probability was 0% and the average warp of the obtained GaN crystal substrates was 55 μm. Regarding slicing of Example A7, the wire breakage probability was 0% and the average warp of the obtained GaN crystal substrates was 66 μm. The results are summarized in Table 1.

2-3. Simultaneous Polishing of Both Main Surfaces of GaN Crystal Substrate

For each of the Examples obtained by slicing of the Examples as described above, both main surfaces of 100 GaN crystal substrates were simultaneously polished and the yield ratio (simultaneous-polishing yield ratio) was examined. Here, the simultaneous-polishing yield ratio is the ratio in percentage of non-defective products without cracks that have been obtained after simultaneously polishing both main surfaces of 100 GaN crystal substrates. Polishing was performed by means of a copper surface plate having a diameter of 380 mm and an aqueous slurry of single-crystal diamond having an average particle size of 5 μm, under the conditions of a surface-plate rotational speed of 40 rpm and a polishing load of 100 gf/cm². The yield ratio of simultaneous polishing of both main surfaces was 100% in Example A1, 100% in Example A2, 100% in Example A3, 100% in Example A4, 100% in Example A5, 76% in Example A6, and 68% in Example A7. The results are summarized in Table 1.

TABLE 1

| | saw wire (tension at break: 21.6 N) | | | | | yield ratio of |
|---|---|---|---|---|---|---|
| | | | ratio of stretch | wire | | simultaneous |
| | stretch | | tension to tension | breakage | average | polishing of both |
| | tension | safety | at break | probability | warp | main surfaces |
| Example A | (N) | factor | (%) | (%) | (μm) | (%) |
| Example A1 | 18.0 | 1.2 | 83.3 | 22 | 12 | 100 |
| Example A2 | 14.4 | 1.5 | 66.7 | 10 | 14 | 100 |
| Example A3 | 13.5 | 1.6 | 62.5 | 0 | 15 | 100 |
| Example A4 | 12.0 | 1.8 | 55.6 | 0 | 28 | 100 |
| Example A5 | 10.8 | 2.0 | 50.0 | 0 | 30 | 100 |
| Example A6 | 8.64 | 2.5 | 40.0 | 0 | 55 | 76 |
| Example A7 | 7.20 | 3.0 | 33.3 | 0 | 66 | 68 |

Referring to Table 1, it is seen from Examples A1 to A7 that a saw wire including a steel wire with a carbon concentration of not less than 0.90 mass % and not more than 0.95 mass %, a silicon concentration of not less than 0.12 mass % and not more than 0.32 mass %, a manganese concentration of not less than 0.40 mass % and not more than 0.90 mass %, a phosphorus concentration of not more than 0.025 mass %, a sulfur concentration of not more than 0.025 mass %, and a copper concentration of not more than 0.20 mass %, and having a diameter of not less than 0.07 mm and less than 0.16 mm, a tensile strength at break of higher than 4200 N/mm², and a curl size of not less than 400 mm could be used to slice the group III nitride crystal body with a tension (stretch tension) of not less than 50% and not more than 65% of the tension at break applied to the saw wire, and thereby obtain a group III nitride crystal substrate of small warpage with a significantly low wire breakage probability.

Specifically, referring to Table 1, under the condition that the stretch tension was 62.5% or less (safety factor was 1.6 or more) of the tension at break of the saw wire, the wire breakage probability of 0% could be achieved. Under the condition that the stretch tension was 50.0% or more (safety ratio was 2.0 or less) of the tension at break of the saw wire, a warp of 30 μm or less of the GaN crystal substrate after slicing could be achieved. Thus, the 100% yield ratio (the yield ratio of simultaneous polishing of both main surfaces) in the process of simultaneously polishing both main surfaces of GaN crystal substrates could be achieved.

### EXAMPLE B

1. Preparation of Group III Nitride Crystal Body

A GaN crystal body (group III nitride crystal body) similar to that of Example A was prepared.

2. Production of Group III Nitride Crystal Substrate

2-1. Preparation of Saw Wire

A saw wire was produced in a similar manner to Example A except that the diameter of the wire was any of 0.16 mm (Example B1), 0.14 mm (Example B2), 0.12 mm (Example B3), 0.10 mm (Example B4), 0.08 mm (Example B5), and 0.07 mm (Example B6). The obtained saw wire of Example B1 had a tension at break of 76 N, a tensile strength at break of 3800 N/mm², and a curl size of 400 mm. The obtained saw wire of Example B2 had a tension at break of 60 N, a tensile strength at break of 3900 N/mm², and a curl size of 410 mm. The obtained saw wire of Example B3 had a tension at break of 32 N, a tensile strength at break of 4050 N/mm², and a curl size of 460 mm. The obtained saw wire of Example B4 had a tension at break of 33 N, a tensile strength at break of 4250 N/mm², and a curl size of 440 mm. The obtained saw wire of Example B5 had a tension at break of 22 N, a tensile strength at break of 4300 N/mm², and a curl size of 410 mm. The obtained saw wire of Example B6 had a tension at break of 17 N, a tensile strength at break of 4300 N/mm², and a curl size of 430 mm.

2-2. Slicing of Group III Nitride Crystal Body

The GaN crystal body was sliced into GaN crystal substrates in a similar manner to Example A except that the tension (stretch tension) applied to the saw wire was 50% (safety factor 2.0) of the tension at break and the distance between wires in the saw wire string was adjusted to define the thickness of the GaN crystal substrate as any of 350 μm, 300 μm, 250 μm, and 200 μm.

The slicing yield ratio of GaN crystal substrates obtained by slicing the GaN crystal body of Example B1 was 96% in the case of the substrate of 350 μm in thickness, 76% in the case of the substrate of 300 μm in thickness, 45% in the case of the substrate of 250 μm in thickness, and 25% in the case of the substrate of 200 μm in thickness. The slicing yield ratio of GaN crystal substrates obtained by slicing the GaN crystal body of Example B2 was 98% in the case of the substrate of 350 μm in thickness, 75% in the case of the substrate of 300 μm in thickness, 62% in the case of the substrate of 250 μm in thickness, and 37% in the case of the substrate of 200 μm in thickness. The slicing yield ratio of GaN crystal substrates obtained by slicing the GaN crystal body of Example B3 was 98% in the case of the substrate of 350 μm in thickness, 85% in the case of the substrate of 300 μm in thickness, 80% in the case of the substrate of 250 μm in thickness, and 75% in the case of the substrate of 200 μm in thickness. The slicing yield ratio of GaN crystal substrates obtained by slicing the GaN crystal body of Example B4 was 100% in the case of the substrate of 350 μm in thickness, 98% in the case of the substrate of 300 μm in thickness, 91% in the case of the substrate of 250 μm in thickness, and 85% in the case of the substrate of 200 μm in thickness. The slicing yield ratio of GaN crystal substrates obtained by slicing the GaN crystal body of Example B5 was 100% in the case of the substrate of 350 μm in thickness, 99% in the case of the substrate of 300 μm in thickness, 98% in the case of the substrate of 250 μm in thickness, and 92% in the case of the substrate of 200 μm in thickness. The slicing yield ratio of GaN crystal substrates obtained by slicing the GaN crystal body of Example B6 was 100% in the case of the substrate of 350 μm in thickness, 99% in the case of the substrate of 300 μm in thickness, 97% in the case of the substrate of 250 μm in thickness, and 94% in the case of the substrate of 200 μm in thickness. Here, the slicing yield ratio is the ratio in percentage of non-defective products without cracks relative to 100 substrates of each thickness produced by slicing the GaN crystal body. The results are summarized in Table 2.

TABLE 2

| | | slicing yield ratio of substrates of | | | |
|---|---|---|---|---|---|
| | diameter of | each thickness (%) | | | |
| | saw wire | thickness | thickness | thickness | thickness |
| Example B | (mm) | 350 μm | 300 μm | 250 μm | 200 μm |
| Example B1 | 0.16 | 96 | 76 | 45 | 25 |
| Example B2 | 0.14 | 98 | 75 | 62 | 37 |
| Example B3 | 0.12 | 98 | 85 | 80 | 75 |
| Example B4 | 0.10 | 100 | 98 | 91 | 85 |
| Example B5 | 0.08 | 100 | 99 | 98 | 92 |
| Example B6 | 0.07 | 100 | 99 | 97 | 94 |

Referring to Table 2, it is seen from Examples B1 to B6 that a smaller diameter of the saw wire provides a higher yield of the group III nitride crystal substrates of each thickness. The degree of increase of the yield of the group III nitride crystal substrates is larger as the thickness of the substrates is smaller.

### COMPARATIVE EXAMPLE R

1. Preparation of Group III Nitride Crystal Body

A GaN crystal body (group III nitride crystal body) similar to that of Example A was prepared.

2. Production of Group III Nitride Crystal Substrate

2-1. Preparation of Saw Wire

A saw wire was produced in a similar manner to Example A except that a steel wire rod corresponding to SWRS82A defined by JIS G3502:2004, specifically a steel wire rod having a carbon concentration of 0.84 mass %, a silicon concentration of 0.18 mass %, a manganese concentration of 0.49 mass %, a phosphorus concentration of 0.008 mass %, a sulfur concentration of 0.008 mass %, and a copper concentration of 0.10 mass %, and having a diameter of 5.5 mm was used. The obtained saw wire had a diameter of 0.08 mm, a tension at break of 15.6 N, a tensile strength at break of 3100 N/mm², and a curl size of 250 mm.

2-2. Slicing of Group III Nitride Crystal Body

The GaN crystal body was sliced in a similar manner to Example A except that the tension (stretch tension) was applied to the saw wire so that the safety factor (the factor determined by dividing the tension at break of the saw wire by the stretch tension on the saw wire) was any of 1.2, 1.5, 1.6, 1.8, 2.0, 2.5, and 3.0, namely the ratio of the stretch tension to the tension at break was any of 83.3%, 66.7%, 62.5%, 56.6%, 50.0%, 40.0%, and 33.3%, specifically the stretch tension applied to the saw wire was any of 13.0 N (Example R1), 10.4 N (Example R2), 9.75 N (Example R3), 8.67 N (Example R4), 7.80 N (Example R5), 6.24 N (Example R6), and 5.20 N (Example R7).

In the case of slicing of Example R1, the wire breakage probability was 30% and the average warp of the obtained GaN crystal substrates was 15 μm. In the case of slicing of Example R2, the wire breakage probability was 11% and the average warp of the obtained GaN crystal substrates was 28 μm. In the case of slicing of Example R3, the wire breakage probability was 4% and the average warp of the obtained GaN crystal substrates was 35 μm. In the case of slicing of Example R4, the wire breakage probability was 0% and the average warp of the obtained GaN crystal substrates was 52 μm. In the case of slicing of Example R5, the wire breakage probability was 0% and the average warp of the obtained GaN crystal substrates was 60 μm. In the case of slicing of Example R6, the wire breakage probability was 0% and the average warp of the obtained GaN crystal substrates was 90 μm. In the case of slicing of Example R7, the wire breakage probability was 0% and the average warp of the obtained GaN crystal substrates was 120 μm. The results are summarized in Table 3.

2-3. Simultaneous Polishing of Both Main Surfaces of GaN Crystal Substrate

In a similar manner to Example A, for each of the above-described Examples obtained by slicing of the Examples, both main surfaces of 100 GaN crystal substrates were simultaneously polished and the yield ratio (simultaneous-polishing yield ratio) was examined. The yield ratio of simultaneous polishing of both main surfaces was 100% in Example R1, 100% in Example R2, 92% in Example R3, 74% in Example R4, 37% in Example R5, 16% in Example R6, and 3% in Example R7. The results are summarized in Table 3.

TABLE 3

| | saw wire | | | | | |
|---|---|---|---|---|---|---|
| | (tension at break: 15.6 N) | | | | | yield ratio of |
| | | | ratio of stretch | wire | | simultaneous |
| | stretch | | tension to | breakage | average | polishing of both |
| Comparative | tension | safety | tension at break | probability | warp | main surfaces |
| Example R | (N) | factor | (%) | (%) | (μm) | (%) |
| Example R1 | 13.0 | 1.2 | 83.3 | 30 | 15 | 100 |
| Example R2 | 10.4 | 1.5 | 66.7 | 11 | 28 | 100 |
| Example R3 | 9.75 | 1.6 | 62.5 | 4 | 35 | 92 |
| Example R4 | 8.67 | 1.8 | 55.6 | 0 | 52 | 74 |
| Example R5 | 7.80 | 2.0 | 50.0 | 0 | 60 | 37 |
| Example R6 | 6.24 | 2.5 | 40.0 | 0 | 90 | 16 |
| Example R7 | 5.20 | 3.0 | 33.3 | 0 | 120 | 3 |

Referring to Table 3, it is seen from Examples R1 to R7 that in the case where the conventional saw wire was used to perform slicing by applying to the saw wire a stretch tension of 55.6% or less (safety factor of 1.8 or more) of the tension at break, the 0% wire breakage probability could be achieved. In this case, however, a significantly large average warp of 52 μm or more was occurred to the group III nitride crystal substrates. In the case where the warp of the group III nitride crystal substrate after the slicing process was larger than 30 μm, the yield ratio of subsequent simultaneous polishing of both main surfaces of the group III nitride crystal substrates was lower than 100%. In order to reduce the average warp of group III nitride crystal substrates to 30 μm or less, it was necessary to perform slicing with a stretch tension of 66.7% or more (safety factor of 1.5 or less) of the tension at break of the saw wire. In this case, however, an extremely high wire breakage probability of 11% or more occurred.

The above-described Examples and Comparative Example provide examples where the two main surfaces of a group III nitride crystal substrate are (0001) plane and (000-1) plane. The results similar to those described above were also obtained from group III nitride crystal substrates whose two main surfaces were non-polarity planes such as {1-100} plane (M plane) and {11-20} plane (A plane) as well as group III nitride crystal substrates whose two main surfaces were semi-polarity planes with an off angle from the above-described M or A plane such as {2-201} plane and {22-43} plane.

It is noted that a saw wire with a tensile strength at break of higher than 4200 N/mm² used for the present invention may also be used as an abrasive-fixed wire on which diamond abrasive is electrodeposited, brazed, or resin-fixed.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method of manufacturing a group III nitride crystal substrate comprising the steps of:
preparing a group III nitride crystal body; and
producing a group III nitride crystal substrate by slicing said group III nitride crystal body with a saw wire, said saw wire including a steel wire having a carbon concentration of not less than 0.90 mass % and not more than 0.95 mass %, a silicon concentration of not less than 0.12 mass % and not more than 0.32 mass %, a manganese concentration of not less than 0.40 mass % and not more than 0.90 mass %, a phosphorus concentration of not more than 0.025 mass %, a sulfur concentration of not more than 0.025 mass %, and a copper concentration of not more than 0.20 mass %,
said saw wire having a diameter of not less than 0.07 mm and less than 0.16 mm, a tensile strength at break of higher than 4200 N/mm², and a curl size of not less than 400 mm, and
a tension of not less than 50% and not more than 65% of a tension at break of said saw wire being applied to said saw wire when said group III nitride crystal body is sliced.

2. The method of manufacturing a group III nitride crystal substrate according to claim 1, wherein said saw wire has a diameter of not less than 0.07 mm and not more than 0.10 mm.

3. The method of manufacturing a group III nitride crystal substrate according to claim 1, wherein said steel wire of said saw wire has a surface plated with brass.

4. The method of manufacturing a group III nitride crystal substrate according to claim 1, wherein said group III nitride crystal substrate has a thickness of not less than 200 μm and not more than 350 μm.

5. A saw wire comprising a steel wire having a carbon concentration of not less than 0.90 mass % and not more than 0.95 mass %, a silicon concentration of not less than 0.12 mass % and not more than 0.32 mass %, a manganese concentration of not less than 0.40 mass % and not more than 0.90 mass %, a phosphorus concentration of not more than 0.025 mass %, a sulfur concentration of not more than 0.025 mass %, and a copper concentration of not more than 0.20 mass %,
said saw wire having a diameter of not less than 0.07 mm and less than 0.16 mm, a tensile strength at break of higher than 4200 N/mm², and a curl size of not less than 400 mm.

6. The saw wire according to claim 5, wherein said saw wire has a diameter of not less than 0.07 mm and not more than 0.10 mm.

7. The saw wire according to claim 5, wherein said steel wire has a surface plated with brass.
